(19) United States
(12) Patent Application Publication
(10) Pub. No.: US 2010/0284768 A1
(43) Pub. Date: Nov. 11, 2010

(54) METHOD AND APPARATUS FOR FEEDING A PULVERIZED MATERIAL

(76) Inventors: Miguel Angel Olin-nuñez, Nuevo Leon (MX); Roberto Marcos Cabrera-Llanos, Nuevo Leon (MX); Iván Jorge Solis-Martinez, Nuevo Leon (MX); Rafael Valadez-Castillo, Nuevo Leon (MX)

Correspondence Address: ABELMAN, FRAYNE & SCHWAB, 666 THIRD AVENUE, 10TH FLOOR, NEW YORK, NY, 10017, US

(21) Appl. No.: 12/734,024

(22) PCT Filed: Oct. 4, 2007
(86) PCT No.: PCT/IB2007/003128

§ 371 Date: Jun. 24, 2010

(51) Int. Cl. C03B 3/00; G01F 11/28; G01G 13/02

(52) U.S. Cl. 414/161; 414/804

(57) ABSTRACT

The present invention is referred to a method and an apparatus for feeding a pulverized material. The apparatus comprises fuel feeding means to supply pulverized fuel. Flexible means are coupled between the fuel feeding means and dosing means for the filling of the dosing means. The dosing means are closed and pressurized once that the dosing means have been filled. The pulverized material is discharged from the dosing means while controlling the pressurization during the discharge, in order to provide a continuous and constant discharge of the pulverized fuel. The apparatus includes means for detecting a minimum level or weight of pulverized fuel in the dosing means, and means for depressurizing the dosing means once that the minimum level of the pulverized fuel has been reached.

### BACKGROUND OF THE INVENTION

1. Field of the Invention

The present invention is related to a method and apparatus for feeding a pulverized material for a glass melting furnace and, in particular to a method and apparatus for feeding a pulverized material for a glass melting furnace which is gradually pressurized to a constant pressure during the unloading of the pulverized material.

2. Related Prior Art

Melting glass has been done in different kinds of furnaces and of the types of fuels, depending on the final characteristics of the product and also regarding the thermal efficiency of the melting and refining processes. Unit melter furnaces have been used to melt glass (by means of gas fuel), these furnaces have several burners along the sides of the furnace, the whole unit looks like a close box where there is a chimney that can be placed either in the beginning of the feeder or at the very end of the furnace, it means, in the downstream of the process. However there is an enormous heat loss in the glass leaving high-temperature operating furnaces. At 2500° F., for example, the heat in the flue gases is 62 percent of the heat input for a natural gas fired furnace.

In order to take advantage of the remaining heat of the flue gases, a more sophisticated and expensive design come out, named as the regenerative furnace. It is well known that, to operate a regenerative glass melting furnace, a plurality of gas burners is associated with a pair of sealed regenerators disposed side-by-side. Each regenerator has a lower chamber, a refractory structure above the lower chamber and an upper chamber above the structure. Each regenerator has a respective port connecting the respective upper chamber with a melting and refining chamber of the furnace. The burners are arranged to burn fuel, such as natural gas, liquid petroleum, fuel oil or other gaseous or liquid fuels which are suitable for use in the glass melting furnace and thereby supply heat for melting and refining the glass making materials in the chamber. The melting and refining chamber is fed with glass making materials at one end thereof at which is located a doghouse and has a molten distributor disposed at the other end thereof, which comprises a series of ports through which molten glass may be removed from the melting and refining chamber.

The burners may be mounted in a number of possible configurations, for example a through-port configuration, a side-port configuration or an under-port configuration. Fuel, e.g. natural gas, is fed from the burner into the incoming stream of pre-heated air coming from each regenerator during the firing cycle, and the resultant flame and products of combustion produced in that flame extend across the surface of the melting glass, and transfer heat to that glass in the melting and refining chamber.

In operation, the regenerators are cycled alternately between combustion air and exhaust heat cycles. Every 20 minutes, or 30 minutes, depending on the specific furnaces, the path of the flame is reversed. The objective of each regenerator is to store the exhausted heat, which allows a greater efficiency and a higher flame temperature that could otherwise be the case with cold air.

For operating the glass melting furnace, the fuel fed to the burners and the combustion air supplied is controlled by measuring at the port mouth and the top of the structure, the quantity of oxygen and combustible material present so as to ensure that within the melting chamber or at points along the melting chamber, the combustion air fed is controlled in excess to that is required for combustion of the fuel being supplied, to ensure a complete combustion of the fuel.

Taking into account the above, the present invention is related to the use a pulverized material as a source of fuel for melting glass and more specifically to a method and apparatus for metering a pulverized material to a furnace for melting glass.

Apparatuses for the continuous gravimetric metering of pourable material are know in the art. Gravimetric metering systems are generally adopted in application when the exact measurement and control of the material in question are of fundamental importance (pharmaceutical industry, chemical industry, cement industry, glass industry, food industry, etc.) or where the flows involved are so small that the error which occurs if a volumetric metering system is used is not tolerable.

Examples of the gravimetric metering apparatuses for pourable material are illustrated in the U.S. Pat. Nos. 4,528,848, 4,661,024, 5,184,892, 5,353,647, 5,670,751 and 6,041,664.

For example the U.S. Pat. No. 4,528,848 of Hans Hafner is related to a device for continuous, gravimetric metering and pneumatic conveying of pourable material provides that a material stream is conveyed over a measuring path while charging a load measuring device and the product of moment load and conveying speed is formed. The conveyor is in the form of a rotor having an essentially vertical axis and conveyor pockets in the form of chambers or cells which are moved with the rotor in a circular orbit over the measuring path. A housing surrounds the rotor in a pressure tight manner and includes a charging aperture and an emptying aperture which are rotationally displaced from one another. A load measuring device is connected to the housing and a tachometer is provided for measuring the angular velocity of the rotor. A pneumatic conveying system is provided which has feed lines respectively communicating with an air feed aperture in the housing and the emptying aperture.

The U.S. Pat. No. 4,661,024 of Hans W. Hafner is related to a method for operating an apparatus for continuous gravimetric metering and feeding of pourable material conveyed by a conveyer through a metering path, the conveyer including a rotor provided with conveyer pockets, having an essentially vertical axis and being arranged within a housing in a tightly sealed manner, the housing being provided with a charging station and a discharging station the latter including ports for connecting a pneumatic feeding system, wherein a gas is supplied to spaces within the housing and the rotor outside the metering path.

The U.S. Pat. No. 5,184,892 of Hans W. Hafner is related to a system and a method for continuous gravimetric metering, pneumatic conveying and/or mixing of pourable materials using metering apparatuses of a type such as e.g. disclosed in U.S. Pat. No. 4,528,848.

The U.S. Pat. No. 5,353,647 of Ludger Toerner is related to an apparatus for measuring a bulk material mass flow by measuring Coriolis forces that are caused by the mass flow passing through a winged wheel. The mass flow is introduced centrally onto the winged wheel, which rotates with a constant r.p.m. and diverts the mass flow radially outwardly. The Coriolis forces and thus the corresponding reaction torques which are proportional to the mass through-flow are measured with the aid of a torque joint interposed between a housing of the winged wheel and a drive motor for the shaft that drives the wheel. Force sensor elements, preferably in the form of bending beams, are incorporated into the torque joint and are deflected by the reaction torque moment applied to the motor housing. These bending beams provide an output signal that is proportional to the mass through-flow through the apparatus.

Other apparatus related to a gravimetric metering of bulk material is claimed in the U.S. Pat. No. 5,670,751 of Hans Wilhelm Hafner which includes a weighting container which is supported on at least one weighing cell connected to a weighing electronics and is connected by flexible connections to a bulk material feed line and a discharge line, wherein a pressure sensor is provided on the weighing container for detecting the pressure in the weighing container and the pressure sensor is connected to the weighing electronics for registering a weighing signal only when a limit pressure value is attained.

And finally, the U.S. Pat. No. 6,041,664 also of Hans W. Hafner es related to a method and an apparatus for continuous, gravimetric metering and mass flow determination of flowable material, with a flowmeter, especially a Coriolis measuring wheel, for determining the instantaneous mass flow and a metering device downstream of the flowmeter.

However, one of the main problems of the apparatuses for metering a pourable material is that, during the moment that the pulverized material is being unloading, a back pressure in the discharge of the material is provoked. This effect makes that the pulverized material be feeding in an irregular form provoking problems in the discharge and conveying of the pulverized material.

Other problem of the apparatuses of the previous art is that the many of the apparatuses were development for handling large quantities of pulverized material (up of one ton), which are extremely expensive and complex.

Notwithstanding the above, the inventors of the present invention patented the U.S. Pat. No. 6,722,294, issued to Roberto Cabrera, on Apr. 20, 2004 is which is referred to apparatus and method are provided for feeding a pulverized material which includes a first storage container for receiving and for discharging a flow of the pulverized material. The apparatus includes a separation chamber attached to the first storage container, which is alternately filled up or emptied out with the pulverized material. A dosing container is connected with an outlet of the separation chamber, for alternately filling the dosing container in accordance with a predetermined storage amount of pulverized material.

However a disadvantage of the U.S. Pat. No. 6,722,294 is this requires of an additional chamber which is attached to first storage container which is alternately filled up or emptied out with the pulverized material, for alternately filling a dosing container in accordance with a predetermined storage amount of pulverized material.

In view of the foregoing, the present invention is related to a method and an apparatus for feeding a pulverized material for a glass melting furnace and some other applications, which supply a constant flow of the pulverized material to a series of burners that are associated with said glass melting furnace, in a relation side by side. Said pulverized material is feeding in a continuous form to burn the pulverized fuel in a melting and refining zone of the glass furnace. The pulverized material is mixed with air for feeding an air-fuel mixture toward each one of the cited burners for the melting of glass.

According with the above the present invention is related to a method and an apparatus for feeding a pulverized material, the apparatus comprises: fuel feeding means, said fuel feeding means having charging and discharging ends, respectively, to receive and to discharge a constant flow of a pulverized material; flexible means attached to the fuel feeding means, said flexible means including an inlet and an outlet; valve means mounted on said inlet and said outlet of said flexible means, said valve means being alternately opened and closed for loading and unloading the pulverized material from said fuel feeding means; a movable dosing container including an inlet and an outlet, the inlet of said movable dosing container being connected with the outlet of said flexible means, for alternately filling the adustable dosing container in accordance to a predetermined storage level or weight of the pulverized material; discharging means attached to the outlet of movable dosing container for continuously discharge the pulverized material; pneumatic conveying means arranged with said discharging means for conveying the material discharged from the discharging means; and weighing means attached with the movable dosing container for controlling the filled up and emptied out of said movable dosing container in accordance with said predetermined storage level or weight of the pulverized material, said movable dosing means being automatically maintained with a constant control of pressurization during the discharging of the pulverized material.

### OBJECTIVES OF THE INVENTION

It is an object of the present invention to provide a method and apparatus for feeding a pulverized material for a glass melting furnace which can continuously operate with a control of pressurization during the discharging of the pulverized material.

It is a further objective of the present invention to provide a method and apparatus for feeding a pulverized material for a glass melting furnace, which is of a simple design, which is handling quantities of pulverized material from between 0 Kg/hr and 1600 kg/hr.

It is another objective of the present invention to provide a method and apparatus for feeding a pulverized material for a glass melting furnace, that is capable of dosing the pulverized material in an continuous form.

These and other objectives and disadvantages of the present invention will be evident to the experts in the field from the following detailed description of the invention, which is illustrated in the attached drawings.

### BRIEF DESCRIPTION OF THE DRAWINGS

FIG. 1 is a schematic plant view of a glass melting furnace of the type side-port;

FIG. 2 is a schematic view of a system for feeding and burning a pulverized fuel to be used with the apparatus for feeding a pulverized material according with the present invention;

FIG. 3 is a longitudinal sectional view of a first embodiment of the apparatus for feeding a pulverized material according with the present invention; and

FIG. 4 is a longitudinal sectional view of a second embodiment of the apparatus for feeding a pulverized material according with the present invention

### DETAILED DESCRIPTION OF THE INVENTION

The invention will be now described in relation to a specific embodiment, taking as a reference a glass melting furnace and a dosing system for a pulverized material, which were illustrated in the pending U.S. patent application Ser. No. 09/816,254, and that will be taken as a reference to describe the function of the present invention.

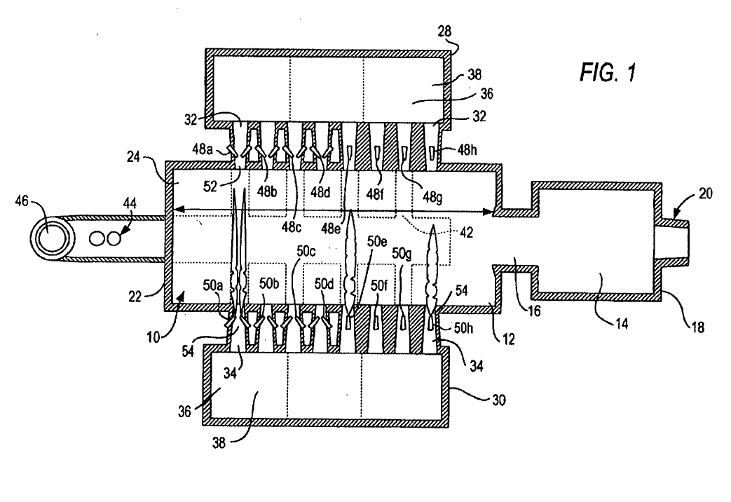

Making now reference to FIG. 1 here is showed a schematic view of a regenerative-type glass melting furnace, of type side port, which comprises a melting chamber 10, a refining chamber 12, a conditioning chamber 14 and a throat 16 between the refining chamber 12 and the conditioning chamber 14. At a front end 18 of the refining chamber 12 comprises a series of forehearth connections 20 through which molten glass is removed from the refining chamber 12. The rear end 22 of the melting chamber 10 including a dog house 24 through which glass making materials are fed by means of a batch charger (not shown). A pair of regenerators 28, 30 are provided by each side of the melting chamber 10. The regenerators 28 and 30 are provided with firing ports 32, 34, connecting each regenerator 28, 30, with the melting chamber 10. The regenerators 28, 30 are provided with a gas regenerator chamber 36 and an air regenerator chamber 38. Both chambers 36 and 38 are connected to a lower chamber 42, which is arranged to be communicated by means of dampers toward a tunnel 44 and a chimney 46 for the exhaust gases. Burners 48a, 48b, 48c, 48d 48e, 48f, 48g and 48h, as well as burners 50a, 50b, 50c, 50d, 50e, 50f, 50g and 50h are arranged by each port 32, 34, in a neck portion 52, 54, of each firing ports 32, 34 in order to burn fuel in the glass melting furnace.

So, when the glass making materials are fed through the dog house 24 in the rear end of the melting chamber 10, the melting glass is melted by the burners 48a-h, 50a-h, and floats in a forward direction until completely melting to pass from the melting chamber 10 to the conditioning chamber 14. During the operation of the furnace, the regenerators 28, 30 are cycled alternately between combustion air and exhaust cycles. Every 20 minutes, or 30 minutes, depending on the specific furnaces, the path of the flame of a series of burners 48a-h or 50a-h are reversed. So, the resultant flame and products of combustion produced in each burner 48a-h, 50a-h, pass across the surface of the melting glass, and transfer heat to that glass in the melting chamber 10 and refining chamber 12.

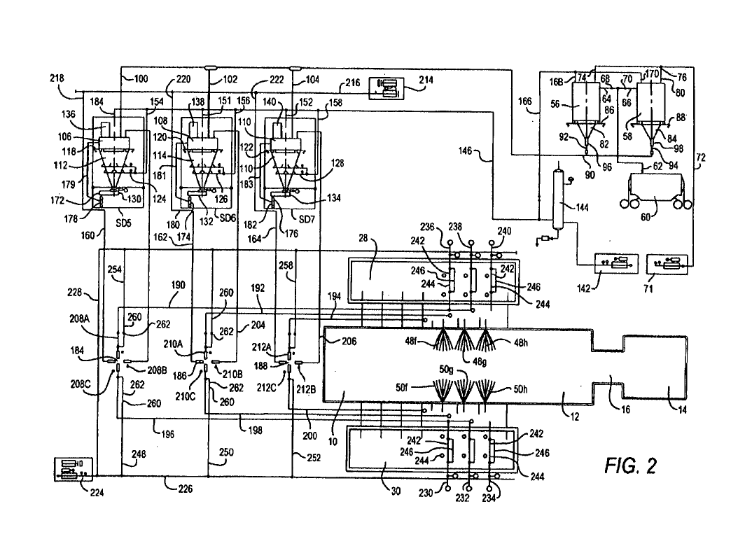

Making now reference to FIG. 2, a system for feeding and burning a pulverized fuel in a glass melting furnace comprises in a first embodiment of the present invention, first storage silos or tanks 56 and 58 for storing pulverized material for use in the glass melting furnace. The storage silos 56, 58 are fed through a wagon or wagon train 60 by means of a first inlet pipe 62 connected between the wagon train 60 and the silos 56, 58. The first main pipe 62 having first branch pipes 64, 66, which are connected respectively to each silo 56, 58, for the filing of each silo 56, 58. Valves 68, 70 are connected to each first branch pipe 64 and 66 to regulate the filing of each silo 56, 58. Each silo 56, 58 is filled by means of a vacuum effect through of a vacuum pump 71 by means of a first outlet pipe 72. The first outlet pipe 72 having second branch pipes 74, 76, to be connected with each silo 56, 58. Valves 78, 80 are connected by each second branch pipes 74, 76, to regulate the vacuum effect provided by the vacuum pump 70 for the filling of each silo 56, 58.

At the bottom of each silo 56, 58, a conical section 82, 84, and a gravimetric coke feeding system 86, 88, are included for fluidizing and for assuring a constant discharge flow of the pulverized coke into a second outlet pipe 90 where the pulverized material is forwarded to a solid fuel dosing system SD-5, SD-6 and SD-7. The second outlet pipe 90 including a third branch pipes 92, 94, connected to the bottom of each conical section 82, 84 of each silo or tank 56, 58. Valves 96, 98, are attached to each third branch pipe 92, 94, to regulate the flow of the pulverized petroleum coke to the second outlet pipe 90.

Making now reference to the dosing system in accordance with the present invention, the pulverized material is received in each solid fuel dosing system SD-5, SD-6 and SD-7 through the second outlet pipe 90. Fourth branch pipes 100, 102 and 104, are connected to the second outlet pipe 90, in order to transport the pulverized coke of the first silos or tanks 56 and 58 toward the solid fuel feeding system SD-5, SD-6 and SD-7. Each solid fuel feeding system SD-5, SD-6 and SD-7, including a second series of silos or tanks 106, 108, 110. The second series of silos 106, 108, 110, comprising a conical section 112, 114, 116; a gravimetric coke feeding system 118, 120, 122; an aeration system 124, 126, 128; a feeder 130, 132, 134; and a filter 136, 138 and 140, for discharging a constant flow of the pulverized coke toward each one of the burners 48f, 48g, 48h and burners 50f, 50g and 50h, as will be described later.

A pneumatic air compressor 142 and an air tank 144 are connected by means of a second main pipe 146. A first inlet branch pipes 148, 150, 152, are connected with the second main pipe 146 for supplying a filtered air—through of the filters 136, 138 and 140—to transport the coke toward the interior of each second series of silos or tanks 106, 108, 110. The second main pipe 146 also includes a first return branch pipes 154, 156, 158, that are connected with each aeration system 124, 126, 128, for permitting an adequate flow of the coke toward a third outlet pipes 160, 162, 164, as will described later. Additionally, a second inlet pipe 166 is connected with the second main pipe 146—after of the air tank 144—, which includes second inlet branch pipes 168, 170, that are connected on the upper part of each silo or tank 56, 58, for injecting air toward the interior of each silo or tank 56, 58.

The solid fuel feeding system SD-5, SD-6 and SD-7 including fourth outlet pipes 172, 174, 176, connected below of each feeder 130, 132, 134. A three-way regulatory valve 178, 180, 182, is connected respectively with the fourth outlet pipes 172, 174, 176, through a first way; a second way is connected with first return pipes 179, 181, 183, for returning the excess of pulverized coke toward each second series of silos or tanks 106, 108, 110, whereas the third way is connected with the third outlet pipes 160, 162, 164, which are used to supply an air-fuel mixture toward an arrangement of a four-way pipe 184, 186 and 188 related with the combustion system as be now described.

Making now reference to the combustion system, this is connected to each solid fuel feeding system SD-5, SD-6 and SD-7 through of a first way of the four-way pipe 184, 186 and 188, which are connected with each third outlet pipes 160, 162, 164 of each solid fuel feeding system SD-5, SD-6 and SD-7. A second way is connected respectively with fourth outlet pipes 190, 192, 194, for feeding the supply air-fuel mixture toward the burners 48h, 48g and 48f. A third way of the four-way pipe 184, 186 and 188, is connected to fifth outlet pipes 196, 198, 200 for feeding the air-fuel mixture toward the burners 50h, 50g and 50f; and a four outlet of the four-way pipe 184, 186, 188, is connected respectively to second return pipes 202, 204, 206, for returning the excess of pulverized coke toward each of the second series of silos or tanks 106, 108, 110. The four-way pipe 184, 186 and 188 having ball valves 208A to C, 210A to C, 212A to C, between a connection portion of the four-way pipe 184, 186 and 188 and the fourth outlet pipes 190, 192, 194; the fifth outlet pipes 196, 198, 200; and the second return pipes 202, 204, 206.

So in this way, during the operation of the furnace, the burners 48a-to-h or 50a-to-h are cycled alternately between combustion and non-combustion cycles. Every 20 minutes, or 30 minutes, depending the temperature set point on the specific furnaces, the path of the flame of a series of burners 48a-to-h or 50a-to-h are reversed. The air-fuel mixture that is arriving through the third outlet pipes 160, 162, 164, is regulated by the four-way pipe 184, 186 and 188 and ball valves 208A-to-C, 210A-to-C, 212A-to-C, for alternating the injection of the air-fuel mixture between the burners 48a-to-h and 50a-to-h. When the alternately operating cycle between the burners 48a-to-h and 50a-to-h is carried out, an amount of air-fuel is returned to the second series of silos or tanks 106, 108, 110 by means of the second return pipes 202, 204, 206.

The transport or secondary air that is supplied through the third outlet pipes 160, 162, 164, is used for transporting the material and for provoking high velocities of coke injection toward the nozzle of the each burner 48a-to-h and 50a-to-h. The transport or secondary air is supplied by means of a pneumatic supply air blower 214 through a third main pipe 216.

Fourth outlet pipes 218, 220 and 222 are connected with the third main pipe 216 and the third outlet pipes 160, 162, 164, for maintaining an elevated relation of the fuel-air mixture that is being supplied to the burners 48a-to-h and 50a-to-h.

For effectuating the combustion cycle of the burners 48a-to-h or 50a-to-h, each burner 48a-to-h or 50a-to-h are fed individually with the air-fuel mixture. This mixture will supplied through an internal tube of each burner 48a-h or 50a-h, and will arrive to a distribution chamber to be distributed to the diverse injection nozzles of each burner 48a-h or 50a-h.

For increasing the turbulence of the flows and the mixture of the pulverized fuel with a pre-heated combustion air in each burner 48a-h or 50a-h, a primary air is injected from a primary air blower 224, which is supplied under pressure through of the injection nozzles of each burner 48a-h or 50a-h. So, the operation of the burners 48a-h or 50a-h, will have a injection of coke through of pneumatic transportation with an elevated relation solid-air and with an relation of primary air of approximately 4% of a stoichiometric air.

A sixth outlet pipe 226 and a seventh outlet pipe 228 is connected with the primary air blower 224. The sixth outlet pipe 226 being connected with fifth branch pipes 230, 232, 234 and the seventh outlet pipe 228 being connected with sixth branch pipes 236, 238, 240. The exit end of each fifth and sixth branch pipes 230, 232, 234, 236, 238, 240, being connected in a direct way with each burner 48f-to-h or 50f-to-h. The flow of primary air in each fifth and sixth branch pipes 230, 232, 234, 236, 238, 240, are regulated individually by an arrangement of a first glove valve 242, a first ball valve 244 and a second glove valve 246.

Additionally, the sixth outlet pipe 226 includes seventh outlet pipes 248, 250 and 252, which are connected respectively with the fifth outlet pipes 196, 198, 200. And, the seventh outlet pipe 228 includes sixth outlet pipes 254, 256, 258, which are connected respectively with the fourth outlet pipes 190, 192, 194. Each sixth and seventh outlet pipes 248, 250, 252, 254, 256, 258, having a check valve 260 and a ball valve 262.

Through the arrangement above described, the primary air blower 224 will supply a primary air to the burners 48f-to-h (left burners) or burners 50f-to-h through the sixth outlet pipe 226 and the seventh outlet pipe 228 and by each fifth and sixth branch pipes 230, 232, 234, 236, 238, 240. The air blower 224 will operate to supply a maximum air flow during the operation of each burner 48f-to-h or burners 50f-to-h, meanwhile a minimum air flow will be provide for the burners 48f-to-h or burners 50f-to-h that are not operating by means of each sixth and seventh outlet pipes 248, 250, 252, 254, 256, 258, to guarantee the better conditions to be cooled.

### Detailed Description of the Feeding Apparatus of the Present Invention.

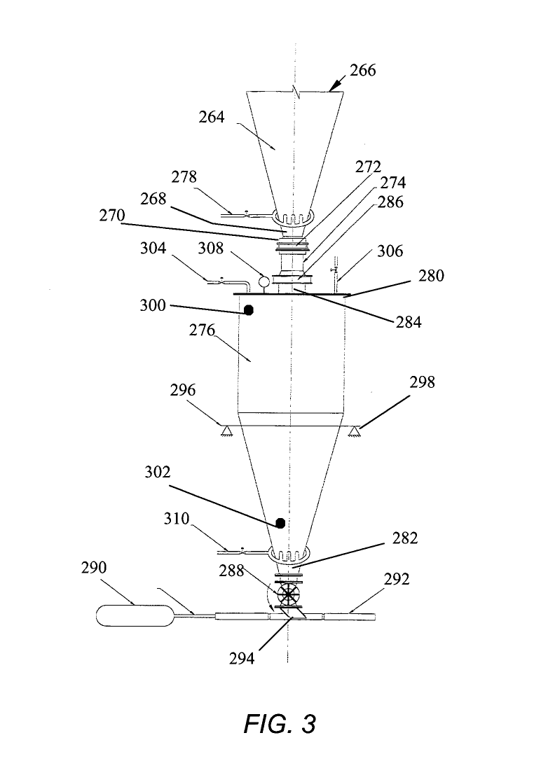

Referring now to FIG. 3, this shows a first embodiment of the feeding apparatus of the present invention, which comprises: a first fixed storage container or silo 264 that includes an upper section 266 and a lower section 268. The upper section 266 including an inlet (not shown) through which pulverized fuel is fed to the first storage container or silo 264. The container or silo 264 also includes a discharge port or exit 270, and a first damper valve 272 is disposed below the discharge or exit 270 for discharging a constant flow of the pulverized material. A flexible joint 274 connected below the first damper valve 272, said flexible joint 274 being expandable or compressed depending of the level or weight of pulverized fuel detected in dosing container 276, as for example a weight hopper, as will be describe later. The first fixed storage silo 264 including a first aeration ring 278, which is activated to deliver more quickly the pulverized fuel to the dosing container 276, an so, reducing the filling time in the dosing container 276.

Making now reference to the dosing container 276, this includes an upper section 280 and a lower section 282. The upper section 280 of the dosing container 276, including an inlet tube 284, which is connected with the lower end of the flexible joint 274. A second damper valve 286 is coupled between the lower end of the flexible joint 274 and the inlet tube 284 of the dosing container. So, the first damper valve 272 and the second damper valve 286 are alternately opened and closed for loading the pulverized material in said dosing container 276. The height of the dosing container 276 is adjusted automatically with an upwardly and downwardly between a lower position and upper position in accordance with a predetermined level or weight of pulverized fuel. The pulverized material stored in the dosing container 276 is discharged in a continuous form through an air lock rotary valve or star feeder or cellular wheel sluice 288 attached to the lower section 282 of dosing container 276 for continuously discharge the pulverized material toward the third outlet pipes 160 or 162 or 164, of the system previously described. An air blower 290 associated with a main pipe 292 is located under the exit end 294 of an air-lock rotary valve or star feeder or cellular wheel sluice 294, in order to convey the pulverized material that is being provided from the dosing container 276 through the main pipe 292. This main pipe 292 can be connected, as an example to each one of the third outlet pipes 160 or 162 or 164 illustrated in FIG. 2. The dosing container 276 including load cells 296, 298, for controlling the filled and emptied of the dosing container 276 in accordance with a predetermined storage level in the same. Two level sensors 300 and 302 are connected in the lower and upper part of the dosing container 276 for the same purpose. Said sensors 300 and 302 being used in case of failure of load cells 296, 298. Associated with the feeding apparatus of the present invention there are connected some series of pipes to balance the pressures exerted during the charge and discharge of the pulverized material. A pressurization pipe 304 connected on the upper section 280 of the dosing container 276, for introduce air to the dosing container 276 to pressurize said dosing container 276. A vent pipe 306 to liberate the air of the of the dosing container 276 during the charge and discharge of the pulverized fuel. A pressure indicator 308 to indicate the pressurization within the dosing container 276. Finally, an aeration ring 310 attached to the lower end 282 of the dosing container 276, which is associated with the pressurization pipe 304 to pressurize more quickly the dosing container 276 when the dosing container 276 has been loaded with the pulverized fuel. In this way, the pressurization time of the movable storage container is reduced as well as the fluidization process during the normal operation is improved

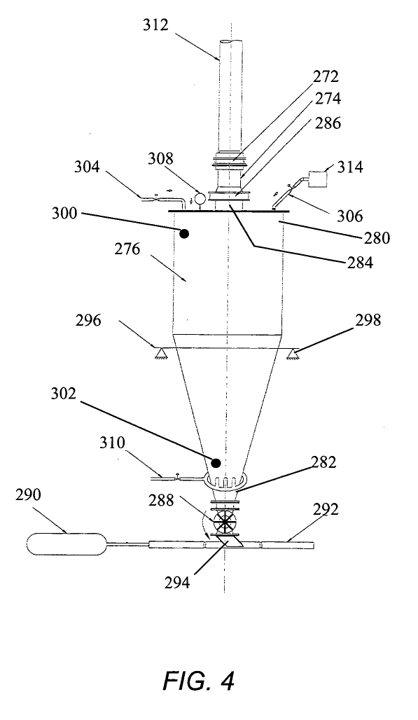

Now making reference to FIG. 4, this shows a second embodiment of the feeding apparatus of the present invention. In this embodiment, the first fixed storage container 264 is substituted by a pulverized fuel conveying line 312, which is connected directly to the first damper valve 272 for discharging a constant flow of the pulverized fuel. The flexible joint 274 is connected below the first damper valve 272, said flexible joint 274 being expandable or compressed depending of the level or weight of pulverized fuel detected in dosing container 276. The function of the dosing container 276, is similar to those described in the first embodiment of he present invention.

However, in this second embodiment the dosing container 276 includes a dust collector 314 to collect the dust of pulverized fuel during the charge step in the dosing container 276. The dust collector 314 is connected to the vent pipe 306 to liberate the air of the of the dosing container 276 during the charge and discharge of the pulverized fuel.

On the basis of the above, the operation of the apparatus for feeding the pulverized material in accordance with the present invention is as follow:

Fill the first storage container 264 with pulverized fuel or provide a pulverized fuel conveying line 312 with pulverized fuel. Open simultaneously the first damper valve 272 and second damper valve 286 to permit the pass of the pulverized fuel from the first storage container 264 or from the pulverized fuel conveying line 312 to the dosing container 276. In this step, if the apparatus includes the first storage container 264, the first aeration ring 278 is activated to deliver more quickly the pulverized fuel to the dosing container 276 and the dosing container 276 is moved downwardly and also the flexible joint 274 is expanded down depending of the level or weight of pulverized fuel detected in dosing container 276. If the apparatus includes the pulverized fuel conveying line 312, the dosing container 276 is moved downwardly and also the flexible joint 274 is expanded down depending of the level or weight of pulverized fuel detected in dosing container 276.

Once the dosing container 276 has been filled, the first damper valve 272 is closed to cut the flow of pulverized fuel and after the second damper valve 286 is closed. Pressurizing the dosing container 276, through the pressurization pipe 304 for maintaining a constant pressure within said dosing container 276 and to secure a consistent flow or discharge of the pulverized fuel in the cellular wheel sluice 288. During the pressurization step the aeration ring 310 is activated to pressurize more quickly the dosing container 276 when the dosing container 276 has been loaded with the pulverized fuel. In this step, the pulverized material stored in the dosing container 276 is discharged in a continuous form, through of the cellular wheel sluice 288 for continuously discharge the pulverized material. The discharge of the pulverized fuel is mixed with a flow of air through a main pipe 292 and the air blower 290. So, when the dosing container is gradually emptied (depending of the level or weight of pulverized fuel) this also is adjusted automatically with an upward movement and the flexible joint 274 is compressed up. Once that a minimum level or weight of pulverized material has been detected in the dosing container 276, the vent pipe 306 is open to depressurize the air of the dosing container 276 during the charge and discharge of the pulverized fuel and the dust collector 314 is activated to collect the dust. After the first damper valve 272 and second damper valve 286 are again open to star the filling process of the dosing container 276. The calculus of the pulverized material in the dosing container 276 is carried out by means of the sensors 300, 302 or by means of the weight of the pulverized material in said dosing 276. Automatic switching means (not shown) are provided for automatically detecting the amount of pulverized fuel by means of either the level of said pulverized material or by means of the weight of the pulverized material in said dosing container.

From the above, a apparatus for feeding a pulverized fuel has been described and will apparent for the experts in the art that many other features or improvements can be made, which can be considered within the scope determined by the following claims.

We claim:

1. A method for feeding a pulverized material, comprising: providing fuel feeding means to supply pulverized fuel; coupling flexible means between the fuel feeding means and dosing means for the filling of said dosing means; filling the dosing means from said fuel feeding means; closing and pressurizing the dosing means once that said dosing means have been filled; discharging said pulverized material from said dosing means while controlling the pressurization in said dosing means during said discharging step, in order to provide a continuous and constant discharge of the pulverized fuel; detecting a minimum level or weight of pulverized fuel in the dosing means; depressurizing the dosing means once that the minimum level of the pulverized fuel has been reached; and filling again the dosing means with the pulverized fuel.

2. The method for feeding a pulverized material as claimed in claim 1, wherein the step of filling the dosing means includes the step of: adjusting automatically the dosing means with an upward and downward movement depending of the level or weight of pulverized fuel in said dosing means.

3. The method for feeding a pulverized material as claimed in claim 1, wherein the flexible means including the step of: adjusting automatically the flexible means with an upward and downward movement in accordance with the level or weight of pulverized fuel in the dosing means.

4. The method for feeding a pulverized material as claimed in claim 1, further including the step of providing aeration means in the fuel feeding means to reduce the filling time in the dosing means.

5. The method for feeding a pulverized material as claimed in claim 1, wherein the pressurizing step includes providing an aeration flow to the dosing means to reduce the pressurization time after the dosing means are filled and to improve the fluidization during the normal operation.

6. The method for feeding a pulverized material as claimed in claim 1, wherein the pressurizing step further includes: maintaining a constant pressure within said dosing means to allow a continuous flow of discharge of the pulverized fuel.

7. The method for feeding a pulverized material as claimed in claim 1, wherein the step of detecting a minimum level or weight of pulverized fuel in the dosing means is carried out by weighing means.

8. The method for feeding a pulverized material as claimed in claim 1, wherein the step of detecting a minimum level or weight of pulverized fuel in the dosing means is carried out by level sensors means.

9. The method for feeding a pulverized material as claimed in claim 1, wherein the step of detecting a minimum level or weight pulverized material includes further the step of: automatically switching the minimum level of the pulverized material in said dosing means is carried out, by means of either the level or by means of the weight of the pulverized material in said dosing means.

10. An apparatus for feeding a pulverized material comprises: fuel feeding means, said fuel feeding means having charging and discharging ends, respectively, to receive and to discharge a constant flow of a pulverized material; flexible means attached to the fuel feeding means, said flexible means including an inlet and an outlet; valve means mounted on said inlet and said outlet of the flexible means, said valve means being alternately opened and closed for loading and unloading the pulverized material from said fuel feeding means; movable dosing means including an inlet and an outlet, the inlet of said movable dosing means being connected with the outlet of said flexible means, for alternately filling the movable dosing means in accordance to a predetermined storage level or weight of the pulverized material; discharging means attached to the outlet of the movable dosing means for continuously discharge the pulverized material, said movable dosing means being automatically maintained with a constant pressurization during the discharging of the pulverized material; and detecting means attached to the movable dosing means for controlling the filled up and emptied out of said movable dosing means in accordance with a predetermined storage level or weight of the pulverized material.

11. The apparatus for feeding a pulverized material as claimed in claim 10, wherein the movable dosing means are automatically adjusted with an upwardly and downwardly movement depending of the level or weight of the pulverized material.

12. The apparatus for feeding a pulverized material as claimed in claim 10, wherein the flexible means is a flexible joint.

13. The apparatus for feeding a pulverized material as claimed in claim 10, wherein the movable dosing meansI are provided with means for controlling the pressure of the air during the discharge of the pulverized material.

14. The apparatus for feeding a pulverized material as claimed in claim 10, wherein the valve means are an upper valve, a lower valve and a venting valve, said upper valve, lower valve and venting valve being synchronized to open and to close during the filling and pressurized of the movable dosing means.

15. The apparatus for feeding a pulverized material as claimed in claim 14, wherein the upper valve and the lower valve are damper valves.

16. The apparatus for feeding a pulverized material as claimed in claim 14, wherein the upper valve and the lower valve are sliding gates.

17. The apparatus for feeding a pulverized material as claimed in claim 10, wherein the movable dosing means includes a discharge valve for decompressing said movable dosing means.

18. The apparatus for feeding a pulverized material as claimed in claim 10, wherein the fuel feeding means is a first storage container.

19. The apparatus for feeding a pulverized material as claimed in claim 19, wherein the first storage container includes aeration means to reduce the filling time of the movable dosing means.

20. The apparatus for feeding a pulverized material as claimed in claim 10, wherein the movable dosing means includes aeration means to reduce the pressurization time after that the movable dosing means are filled and to improve the internal fluidization.

21. The apparatus for feeding a pulverized material as claimed in claim 10, wherein the movable dosing means comprises, means to maintain a constant pressurization in said movable dosing means during the discharging of the pulverized material.

22. The apparatus for feeding a pulverized material as claimed in claim 10, wherein the fuel feeding means is a fuel conveying line.

23. The apparatus for feeding a pulverized material as claimed in claim 10, wherein the fuel feeding means is a storage container.
